(19) United States
(12) Patent Application Publication
(10) Pub. No.: US 2012/0036122 A1
(43) Pub. Date: Feb. 9, 2012

(54) CONTEXTUAL INDEXING OF SEARCH RESULTS

(75) Inventors: Andrei Broder, Menlo Park, CA (US); Evgeniy Gabrilovich, Sunnyvale, CA (US); Vanja Josifovski, Los Gatos, CA (US); George Mavromatis, Mountain View, CA (US); Jianlin Wang, Sunnyvlae, CA (US); Donald Metzler, Los Angeles, CA (US)

(73) Assignee: Yahoo! Inc., Sunnyvale, CA (US)

(21) Appl. No.: 12/852,415

(22) Filed: Aug. 6, 2010

(51) Int. Cl. G06F 17/30

(52) U.S. Cl. 707/723; 707/E17.084

(57) ABSTRACT

Briefly, embodiments of a method or a system of contextual indexing of search results is disclosed.

### FIELD

The present disclosure is related to search engines and searching of the Internet.

### BACKGROUND

The difficulty of locating or retrieving information of interest typically increases as the total amount of information available increases. For example, as more information of potential interest becomes available, information of particular interest may be more difficult to locate. For the Internet, search engines are available to aid in retrieving information of interest, yet a search may at times return information that is of little or no relevance to a searching party. In response to a query, a search engine may crawl tens of billions of Web pages, for example. Finding useful relevant results, therefore, remains a continuing challenge.

A search engine typically performs a search in two phases. In a first phase, candidate documents or pages that may contain a query word are retrieved. This phase may be implemented or viewed as a variant of a “bag-of-words” approach, for example. In a second phase, candidate documents or pages are re-ranked to reflect an estimate of relevance. A re-ranking process may employ, for example, machine learning techniques. Improvements in ranking of candidate pages or documents continue to be desirable.

### BRIEF DESCRIPTION OF THE DRAWINGS

Non-limiting or non-exhaustive embodiments will be described with reference to the following figures, wherein like reference numerals refer to like parts throughout the various figures unless otherwise specified.

FIG. 1 is a schematic diagram of an embodiment of a system;

FIG. 2 is a schematic diagram of an embodiment of a scoring component; and

FIG. 3 are tables illustrating two examples of signature site indices.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses, or systems that may be known by one of ordinary skill have not been described in detail so as not to obscure claimed subject matter.

The difficulty of locating or retrieving information of interest typically increases as the total amount of information available increases. For example, as more information of potential interest becomes available, information of particular interest may be more difficult to locate. For the Internet, search engines are available to aid in retrieving information of interest, yet a search may at times return information that is of little or no relevance to a searching party. In response to a query, a search engine may crawl tens of billions of Web pages, for example.

A search engine typically performs a search in two phases. In a first phase, candidate documents or pages that may contain a query word are retrieved. This phase may be implemented or viewed as a variant of a “bag-of-words” approach, for example. In a second phase, candidate documents or pages may be re-ranked to reflect an estimate of relevance. A re-ranking process may employ, for example, machine learning techniques. Over recent years, for example, applying machine learning to rank has become a standard or commonly used technique.

However, nonetheless, ranking generally still evaluates documents in isolation. Thus, this approach may overlook information encoded in page organization. For example, pages may essentially be scored by disregarding its immediate neighborhood on the Web. In at least one embodiment in accordance with claimed subject matter, instead, relevance information for Web searching, for example, may involve evaluating a page in context of a host Web site. In at least one embodiment, contextual site content for a Web site may be employed for ranking pages, for example. Contextual site content may refer a site representation, which is intended to represent content of a site contextually. Likewise, contextual local content may refer to a representation of content intended to represent local content contextually, but which may encompass something other than a site. Of course, contextual local content may also be for a site as well. In at least one embodiment, as an illustrative example, anchor text may be aggregated over links pointing to a site rather than those pointing to a single page, for example. In at least one embodiment, at least two indices may be formulated, a conventional or more traditional page index and a site index. At runtime, a query may be executed against both indices, and a page score for a given query may be produced using both. Of course, these are example embodiments provided primarily for purposes of illustration. Claimed subject matter is not intended to be limited in scope to these specific illustrative examples.

In at least one embodiment, a page or document is considered or evaluated in context, e.g., in context of a host Web site. An advantage may be that textual clues may be incorporated that may otherwise be difficult to capture. Likewise, anchor text sparsity may also be addressed. At times, pages may have no meaningful or little meaningful incoming anchor text. However, an embodiment in which anchor text is aggregated at the site level, for example, allows for cross-use of anchor text for multiple pages.

One might envision multiple ways to incorporate site-level information. One way to do so, which may be reminiscent of traditional page-level ranking, may be to use site information to augment a page index representation. A drawback, however, may be that a page index may become prohibitively large owing to massive text duplication. For example, if site text were added to a page index this might occur. An alternative approach, in at least one embodiment, may involve formulating or maintaining at least two indices: a URL or page index and a separate site index. In at least one embodiment, the latter index may be populated with site representations, which are intended to represent contextual content of a site.

In at least one embodiment, a page may be scored with respect to both indices, and resulting scores may be passed to a ranking component or module, for example, which may use a site score as a feature in ranking. A two-index approach, for example, may provide a way to augment a page ranking process with site information without having to replicate expansion site information. Of course, an embodiment may also employ more than two indices.

A number of approaches to constructing a site index are possible and claimed subject matter is not intended to be limited to a particular approach. For example, as described in more detail below, one embodiment may employ incoming anchor text. Another embodiment may employ a site signature index built using pages of a site. Likewise, combinations of approaches may be employed in an embodiment.

Although claimed subject matter is not limited in scope in this respect, in one embodiment, for example, a search ranking paradigm may combine evidence from a page index with a site index. A site index may, for example, provide more contextually relevant information for a page, at least partially reflecting, for example, site topicality. Several approaches for representing site content are described, although claimed subject matter is not limited in scope to any particular approach, including those described below as illustrative. One embodiment may employ information external to a site (e.g., incoming anchor text), internal to a site (e.g., a sample of site pages), or a combination of both types of sources, which may be employed to construct a site signature index using feature selection techniques, described in more detail later, that may be applied to identify site features, for example.

In at least one embodiment, structure of the Web, such as, in particular, organization of Web pages at a site may be applied to affect search relevance. Matching query text to document text, for example, comprises one potential technique. Textual matching strategies have applied two main approaches. One approach may employ implicit structure for textual matching. Although using implicit structure for textual matching has been shown to be useful by various researchers, it may be largely infeasible to apply to large collections, such as the Web. Clustering billions of documents, for example, may be too “expensive,” for example, in terms of computational resources.

Another approach may employ using explicit structure. Of course, not all document collections are structured, but for those that are, explicit structure may provide benefits. For example, document clustering is not necessary. Furthermore, explicit structure is more likely to be accurate than an implicit structure approach. Embodiments in accordance with claimed subject matter differ from these approaches in several ways, however. For example, in one embodiment, a site index is constructed. This may be less computationally demanding than constructing an overall explicit contextual index, for example. A Web site typically comprises a reasonably well-defined concept, as opposed to a cluster or a context. Likewise, as discussed in more detail, a site index may have a relatively small footprint. Thus, embodiments may be relatively implementable practically speaking, for example. Furthermore, employing a site index may be more general and applicable to existing search engines since assumptions about how indexing, scoring, or ranking is done within a search engine is not generally employed.

In at least one embodiment, a site index may be formed to allow a URL, which may, for example, comprise an electronic document, such as a page, to be considered in context. A site index may be formed to allow an electronic document, indicated by a URL, to be considered or evaluated within a context formed by a site hosting the electronic document, for example. It is noted here that while the terms URL, page and electronic document are used interchangeably throughout this specification, and intended meaning may vary slightly in specific situations, in general, this use interchangeably is to suggest that a broad meaning is intended with more narrow terms merely providing a specific example within a broader meaning. Likewise, the terms site and Web site are used interchangeably with a similar intention. Thus, these terms are intended to take on reasonably broad understandings.

Thus, in at least on example embodiment, a site index may be generated to relate an electronic document to its host site. In so doing, parts of an electronic document that may be representative of content of a host site, for example, may be identified. Additionally, parts that are incidental may be omitted. As previously indicated, an index may provide textual clues that may be difficult or challenging to capture otherwise or by other approaches or techniques. An index may be employed, for example, to affect ranking of search results, in online advertising, or in other applications.

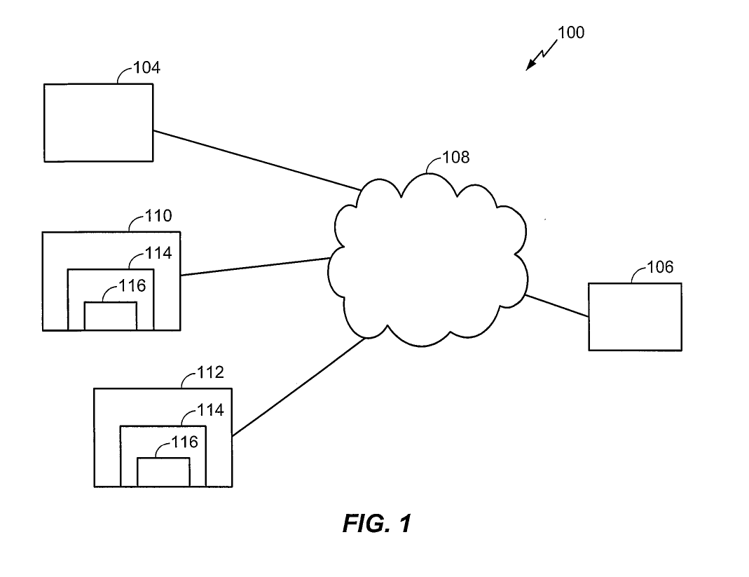

FIG. 1 is a schematic diagram illustrating embodiment 100 of a system or network. Embodiment 100 in this example is shown to include server 102, 110 and 112. Server 102 may, for example, host a search engine that may employ one or more site indices, as described in more detail below. Likewise, a client 106, for example, may be employed to access or retrieve information via or from Internet 108. Likewise, via Internet 108, client 106 may access information available from servers 102, 110, or 112, for example. Servers 110 or 112, for example, may host a plurality of sites 114. Any hosted site 114 may likewise include a plurality of pages or electronic documents 116 addressable via one or more URLs, for example. It is, of course, understood that this is a simplified example that is not meant to be limiting. For example, a web site or a search engine may be encompassed over multiple or even many servers.

A page 116, for example, of a hosted site, may include content provided by publishers, such as articles or other content, displayed in a variety of formats. Content information may comprise text, images, video, audio, animation, program code, hyperlinks, or other content and may be provided in any one of a variety of possible formats so that the content is capable of being accessed by a client, such as client 106. For example, and without limitation, content may be formatted according to hypertext markup language (HTML); however, it is intended that any format for content be included within the scope of claimed subject matter.

In at least one embodiment, a page index, also referred to as a URL index, and a site index may be used in combination. For example, at runtime a query may be executed against both indices, and a score for a given query may be produced by combining the scores of a page index and site index during a ranking process. For example, a URL included in search results may be scored with respect to a URL index and with respect to a site index. Resulting URL index-site index combined scores may be employed as a feature in ranking search results, for example, in at least one embodiment. Of course, claimed subject matter is not limited in scope to this example embodiment. For example, in other embodiments, other approaches to using a site index may be employed.

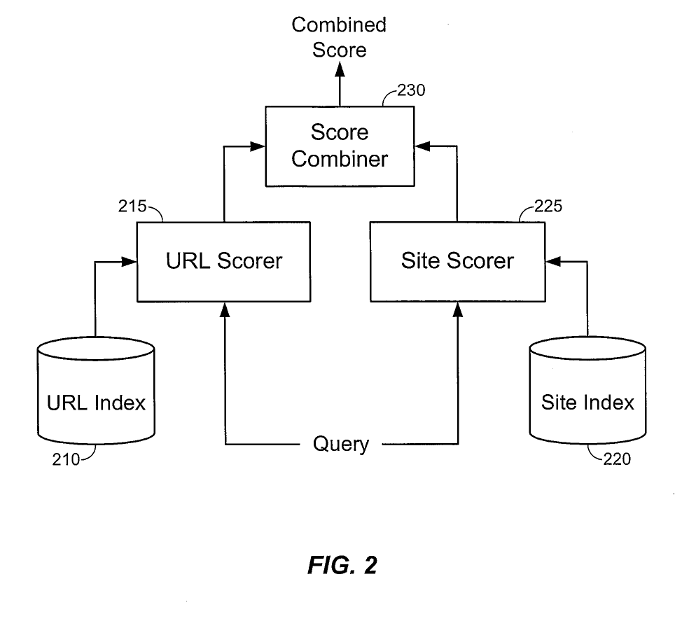

FIG. 2, for example, is a schematic diagram providing a high level overview of an embodiment employing these two components. An indexing component in this example embodiment may construct two search indices, a URL index 210 and a site index 220, as previously described. A URL index may comprise a standard Web search index, in which an indexing unit may comprise a Web page, for example. For a site index, however, an indexing unit may comprise a site, as opposed to a Web page. In at least one embodiment, a site index may be used to encode contextual information for pages within a site. A scoring component, as described in more detail below, may be employed to execute queries against URL and site indices. Thus, URL scorer 215 and site scorer 225 are also illustrated in FIG. 2. Queries may in at least one embodiment be executed against two indices in parallel to reduce latency. Results for the two indices may, such as illustrated, for example, be aggregated, such as by a score combiner 230, to produce a site-specific retrieval score, which may be used as a feature in ranking search results.

A number of approaches may be employed to generate a site index and claimed subject matter is not limited in scope to any particular approach. For example, in at least one embodiment, textual information may be collected from one or more pages within a site. Likewise, a variety of approaches may be employed to determine the textual information to be collected. A concatenation of a complete set of textual information for a site may be employed as one non-limiting example. Of course, a disadvantage of employing a complete set of textual information may be that relatively large indices are produced. Alternatively, samples of textual information may be collected. Sampling textual information may involve a variety of factors and claimed subject matter is not intended to be limited to a particular approach. However, a possible approach for sampling may include for a site, www.site.com, for example, issuing the site as a query to a search engine and collecting the top N or so returned site URLs as a sample of the site, where N is a positive integer value. Of course, claimed subject matter is not limited in scope to employing this particular approach. Furthermore, again, samples of textual information, if employed, may be concatenated. Likewise, in other embodiments, again, other types of information, such as image, video, or audio information, may likewise be sampled; although in the examples that follow textual information is employed to be illustrative.

In at least one embodiment, a site index may comprise an anchor-text site index. A hyperlink may connect or link to a resource or electronic document. Anchor text refers to text associated with the hyperlink. External anchor text is text external to a site associated with a hyperlink that links or connects to the site or a location within the site. Anchor text may be a useful textual source since it may be lexically similar to a query, for example. However, in some situations, little or no external anchor text for a site may exist. This issue is recognized and discussed, for example, in a paper by D. Metzler, J. Novak, H. Cui, and S. Reddy, entitled, Building, Enriched Document Representations Using Aggregated Anchor Text. In Proc. 32^{nd} Ann. Intl. ACM SIGIR Conf. on Research and Development in Information Retrieval, pages 219-226, New York, N.Y., U.S.A. ACM. Aggregating external anchor text associated with different hyperlinks which may all point to a particular site may provide one useful approach. Of course, claimed subject matter is not limited in scope in this respect. There are a variety of possible approaches and claimed subject matter is not limited to any particular approach. However, in at least one embodiment, external anchor text from multiple hyperlinks pointing to a particular website may be concatenated to form a site index.

In at least one embodiment, a site index may instead or in addition comprise a site signature index. In this context, the term site signature index refers to a selection of words or phrases chosen to be a contextually relevant representation of a site. For example, in an embodiment, a feature selection approach may be applied to identify characteristic text features of a site, as described in more detail below.

Although claimed subject matter is not limited in scope in this respect, in at least one embodiment, pages of a site may be tokenized into terms such as words or phrases. A term frequency-inverse document frequency (tf-idf) estimate may be generated for the tokenized pages of the site. A term frequency-inverse document frequency (tf-idf) estimate typically comprises a statistical measure used at times to evaluate relative significance of a term in a collection of documents. In this example, it may be applied to assist in evaluating contextual relevance across a site, as described below.

A tf-idf vector may be constructed for a page for the words and phrases of that page. Thus, a tf-idf value of a term may be estimated as proportional to the number of times the term appears in a document, such as page of a site. This estimate may, however, be offset by the frequency of the term across the pages of the site. Therefore, a site level value for a term across a site may be estimated as the sum of a term's tf-idf values across the site. Terms having the highest site level value may be identified. For example, in an embodiment, M terms having the highest site level estimate may be selected, where M comprises a positive integer value large enough to potentially be somewhat comprehensive, yet not so large as to be unduly cumbersome, as an example. Without limitation, for example, a value of M in the range of 500 to 2000, such as 1000, for example, is expected to yield satisfactory results.

Site level tf-idf values may be useful for identifying terms to represent a site, but may not fully reflect semantic relatedness to the site. To quantify semantic relatedness, semantic similarity between a term and a site may be computed. For example, in at least one embodiment, a centroid vector of a site may be constructed using tf-idf values of terms of the pages of a site. For particular terms, those terms may be submitted as a query to a Web search engine and a centroid vector of top search results may be constructed. Top search results may be chosen in any one of a variety of ways, such as a top percentile ranking or as a fixed number of the top results, for example.

To form a site signature index in at least one embodiment, K term features, or a range of term features, with the largest semantic similarity score between those term and the site may be employed. Semantic similarity between a term and a site may, for example, be expressed as:

Sim(t,S)=cos(E(t),μ(S)) (1)

where: t denotes a term; E(t) denotes a term's expansion vector using web search results; μ(S) denotes the centroid of site S; and cos denotes the cosine similarity metric.

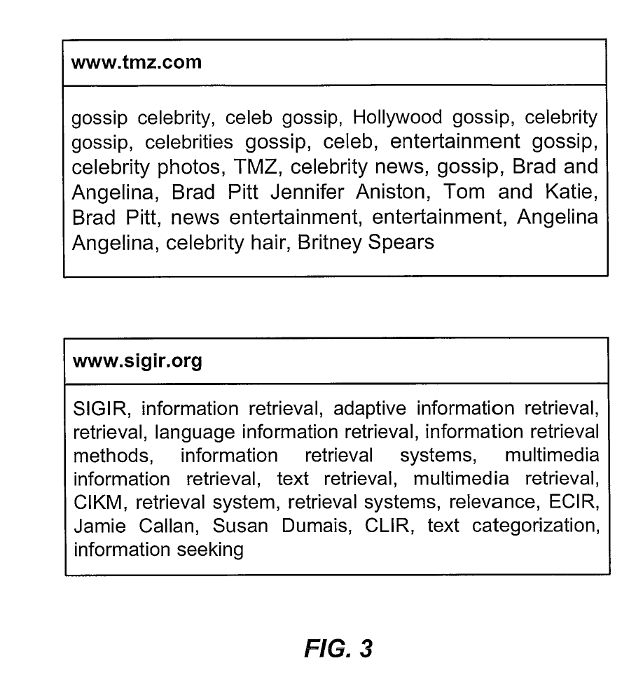

FIG. 3 illustrates site signature indexes for the Websites www.tmz.com and www.sigir.org using an approach similar to the embodiment described above. The first site signature index is for the Website TMZ.com, which is dedicated to celebrity news and gossip and the second is for the Website of the ACM Special Interest Group on Information Retrieval. The site signature indices illustrate contextually relevant text that may be employed in ranking search results, for example.

In at least one embodiment, as previously suggested, a scoring component may be employed to compute retrieval scores using URL and site indices and combining respectively computed scores. Any one of a number of methods or approaches to combining scores may be employed and claimed subject matter is not limited to a particular approach. As simply one illustrative example, a linear combination of scores may be employed substantially in accordance with the following:

f(Q,U)=(1−λ)·Surl(Q,U)+λ·Ssite(Q,site(U)) (2)

Q denotes a query; U denotes a page being scored; S_{URL}(Q,U) denotes a URL index score; Sₛᵢₜₑ(Q, site(U)) denotes a site index score; and denotes a parameter affecting the linear combination of scores. Score f(Q,U) may be used to rank results (returned, for example, in an initial bag-of-words search), or may be used as a feature in a machine-learned ranking function or operation, for example.

URL and site scores may be generated using a variety of approaches. Three illustrative examples of embodiments are provided; although, of course, claimed subject matter is not limited in scope to these example embodiments. For example, in at least one embodiment, a language modeling approach to generating URL and site scores may be employed substantially in accordance with the following:

$$S ( Q , U ) = {\sum }_{ωɛ Q} log \frac{tf ( ω , U ) + μ \frac{cf ( ω )}{\vert C \vert}}{μ + \vert U \vert} \qquad ( 3 )$$

where: tf(ω,U) denotes the number of times that term ω occurs for page U; cf(ω) denotes the total number of times that ω occurs for the site; |U| denotes the length of the page; |C| denotes the length of the site; and μ denotes a parameter affecting degree of smoothing. In at least one embodiment, a URL index score, S_{URL}(Q,U), and site index score, Sₛᵢₜₑ(Q, site(U)), may be combined, for example, substantially in accordance with relation (2), having been generated substantially in accordance with relation (3).

As another example, an alternate embodiment may employ a BM25F-SD ranking function. Scores may, for example, be computed substantially in accordance with the following:

$$S ( Q , U ) = λ T {\sum }_{w ɛ Q} ω t ( ω , U ) + λ o {\sum }_{ω i , ω i + 1 ɛ Q} ω t ( {}^{``} ω i ω i + {1}^{″} , U ) + λ U {\sum }_{ω i , ω i + 1 ɛ Q} ω t ( prox ( ω i , ω i + 1 ) , U ) \qquad ( 4 )$$

where: Ωt(Ω,U) denotes the BM25F weight of the term Ω in page U; Ωt(“ΩᵢΩᵢ₊₁”,U) denotes the BM25F weight of the exact phrase “ΩᵢΩᵢ₊₁” in page U; Ωt(prox(ΩᵢΩᵢ₊₁,U) denotes the BM25F weight of terms Ωᵢ and Ωᵢ₊₁ occurring within a window of 8 terms of each other (this is a proximity component); and λ_{T}, λ₀, and λ_{U} are parameters. In this context, a BM25F-SD ranking function comprises a combination of BM25F weighting and sequential dependence modeling (SD). BM25F weighting is described, for example, in an article: H. Zaragoza, N. Craswell, M. Taylor, S. Saria, and S. Robertson. Microsoft Cambridge at TREC 13: Web and Hard Tracks. In Proc. 13th Text Retrieval Conference, 2004. Sequential dependence modeling is described, for example, in: D. Metzler and W. B. Croft. A Markov Random Field Model for Term Dependencies. In Proc. 28th Ann. Intl. ACM SIGIR Conf. on Research and Development in Information Retrieval, pages 472-479, 2005. The resulting BM25-SD approach comprises a ranking function that combines term weighting with term proximity matching. BM25F-SD assigns different weights to matches for different document fields (e.g., title, body, anchor text, etc.). BM25F-SD is described in: D. Metzler. Beyond Bags of Words: Effectively Modeling Dependence and Features in Information Retrieval, PhD thesis, University of Massachusetts, Amherst, Mass., 2007. In an embodiment, for example, a URL index score, S_{URL}(Q,U), and site index score, Sₛᵢₜₑ(Q, site(U)), may be combined, for example, substantially in accordance with relation (2), having been generated substantially in accordance with relation (4).

As previously noted, in an alternate embodiment, a combined score may be used as a feature in another ranking function, such as a machine learned ranking function. Machine learned ranking functions are described, for example, by T. Y. Liu in, Learning to Rank for Information Retrieval. Foundations and Trends in Information Retrieval, 3(3), 2009. Machine learned ranking functions have been employed to combine evidence from multiple sources, including textual features, spam features, click features, and links-based features, for example. A machine learned ranking function may be adapted to use a site index as a feature in a ranking function. For example, a site score Sₛᵢₜₑ(Q,site(U)) may be used as a feature, where Sₛᵢₜₑ(Q,site(U)) may be generated, as previously described, using language modeling, BM25F-SD or any other scoring function. Alternatively, a combined site and URL score f(Q,U), such as previously described, for example, may be used as a feature in a machine-learned ranking function.

It will, of course, be understood that, although particular embodiments have just been described, claimed subject matter is not limited in scope to a particular embodiment or implementation. For example, one embodiment may be in hardware, such as implemented on a device or combination of devices, as previously described, for example. Likewise, although the claimed subject matter is not limited in scope in this respect, one embodiment may comprise one or more articles, such as a storage medium or storage media, as described above for example, that may have stored thereon instructions that if executed by a specific or special purpose system or apparatus, for example, may result in an embodiment of a method in accordance with claimed subject matter being executed, such as one of the embodiments previously described, for example. As one potential example, a specific or special purpose computing platform may include one or more processing units or processors, one or more input/output devices, such as a display, a keyboard or a mouse, or one or more memories, such as static random access memory, dynamic random access memory, flash memory, or a hard drive, although, again, the claimed subject matter is not limited in scope to this example.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Reference throughout this specification to “one embodiment” or “an embodiment” may mean that a particular feature, structure, or characteristic described in connection with a particular embodiment may be included in at least one embodiment of claimed subject matter. Thus, appearances of the phrase “in one embodiment” or “an embodiment” in various places throughout this specification are not necessarily intended to refer to the same embodiment or to any one particular embodiment described. Furthermore, it is to be understood that particular features, structures, or characteristics described may be combined in various ways in one or more embodiments. In general, of course, these and other issues may vary with the particular context of usage. Therefore, the particular context of the description or the usage of these terms may provide helpful guidance regarding inferences to be drawn for that context.

Likewise, the terms, “and” and “or” as used herein may include a variety of meanings that also is expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe some combination of features, structures or characteristics. Though, it should be noted that this is merely an illustrative example and claimed subject matter is not limited to this example.

In the preceding description, various aspects of claimed subject matter have been described. For purposes of explanation, systems or configurations were set forth to provide an understanding of claimed subject matter. However, claimed subject matter may be practiced without those specific details. In other instances, well-known features were omitted or simplified so as not to obscure claimed subject matter. While certain features have been illustrated or described herein, many modifications, substitutions, changes or equivalents will now occur to those skilled in the art. It is, therefore, to be understood that the appended claims are intended to cover all such modifications or changes as fall within the true spirit of claimed subject matter.

1. A method of ranking search results comprising:
ranking said search results via one or more special purpose computing devices based at least in part on a URL index and based at least in part on a site index.

2. The method of claim 1, wherein said site index comprises an index of anchor text for a site hosting a URL of said search results.

3. The method of claim 1, wherein said site index comprises an index of website text for a site hosting a URL of said search results.

4. The method of claim 1, wherein said site index comprises a site signature index of a site hosting a URL of said search results.

5. A method of ranking search results comprising:
ranking said search results via one or more special purpose computing devices based at least in part on local context of one or more of said search results.

6. The method of claim 5, wherein said local context of one or more of said search results comprises local context within a host website of said one or more of said search results.

7. The method of claim 6, wherein said local context within a host website of said one or more of said search results comprises a site index.

8. The method of claim 7, wherein said ranking further includes scoring said site index.

9. The method of claim 8, wherein said scoring comprises applying a language model to score said site index.

10. The method of claim 8, wherein said scoring comprises applying machine learning ranking to score said site index.

11. The method of claim 8, wherein said scoring comprises applying a BM25F-SD ranking function to score said site index.

12. A method of ranking search results comprising:
ranking a URL of said search results via one or more special purpose computing devices based at least in part on explicit contextual usage within a website hosting said URL of search terms producing said search results.

13. The method of claim 12, wherein said ranking further includes scoring said search results based at least in part on explicit contextual usage within a website hosting said URL of search terms producing said search results.

14. An article comprising: a storage medium having stored thereon instructions executable by a special purpose computing device to: rank search results based at least in part on a URL index and based at least in part on a site index.

15. The article of claim 14, wherein said instructions are further executable by said special purpose computing device so that said site index comprises an index of anchor text for a site hosting a URL of said search results.

16. The article of claim 14, wherein said instructions are further executable by said special purpose computing device so that said site index comprises an index of website text for a site hosting a URL of said search results.

17. The article of claim 14, wherein said instructions are further executable by said special purpose computing device so that said site index comprises a site signature index of a site hosting a URL of said search results.

18. An apparatus comprising: a special purpose computing device;
wherein said special purpose computing device being capable of ranking search results based at least in part on a URL index and based at least in part on a site index.

19. The apparatus of claim 18, wherein said special purpose computing device is further capable of ranking based at least in part on said site index comprising an index of anchor text for a site hosting a URL of said search results.

20. The apparatus of claim 18, wherein said special purpose computing device is further capable of ranking based at least in part on said site index comprising an index of website text for a site hosting a URL of said search results.

21. The apparatus of claim 18, wherein said special purpose computing device is further capable of ranking based at least in part on said site index comprising a site signature index of a site hosting a URL of said search results.
